(19) United States
(12) Patent Application Publication
(10) Pub. No.: US 2006/0166676 A1
(43) Pub. Date: Jul. 27, 2006

(54) Apparatus and method for dynamic and scalable bandwidth in a CDMA wireless network

(75) Inventors: Purva R. Rajkotia, Plano, TX (US); Chanakya Bandyopadhyay, Richardson, TX (US); Sanjaykumar Kodali, Dallas, TX (US)

Correspondence Address: DOCKET CLERK, P.O. DRAWER 800889, DALLAS, TX, 75380, US

(73) Assignee: SAMSUNG ELECTRONICS CO., LTD., Suwon-city (KR)

(21) Appl. No.: 11/176,419

(22) Filed: Jul. 7, 2005

Related U.S. Application Data
(60) Provisional application No. 60/645,659, filed on Jan. 21, 2005.
(60) Provisional application No. 60/645,660, filed on Jan. 21, 2005.
(60) Provisional application No. 60/645,836, filed on Jan. 21, 2005.

(51) Int. Cl. H04B 7/15

(52) U.S. Cl. 455/452.2; 455/450

(57) ABSTRACT

A wireless network and base station capable of communicating with a plurality of mobile stations in a coverage area of the wireless network, wherein the base station is configured to transmit information indicating the bandwidth and frequencies supported by that base station.

### CROSS-REFERENCE TO RELATED APPLICATION AND CLAIM OF PRIORITY

The present invention is related to that disclosed in U.S. Provisional Patent No. 60/645,659, filed Jan. 21, 2005, entitled “Apparatus and Method for Dynamic and Scalable Bandwidth in a CDMA Wireless Network”. U.S. Provisional Patent No. 60/645,659 is assigned to the assignee of the present application. The subject matter disclosed in U.S. Provisional Patent No. 60/645,659 is hereby incorporated by reference into the present disclosure as if fully set forth herein. The present invention hereby claims priority under 35 U.S.C. §119(e) to U.S. Provisional Patent No. 60/645,659. The present application also claims priority to U.S. Provisional Patent Application No. 60/645,836, filed Jan. 21, 2005, and No. 60/645,660, filed Jan. 21, 2005, both of which are hereby incorporated by reference.

### TECHNICAL FIELD OF THE INVENTION

The present invention relates generally to wireless networks and, more specifically, to a mechanism for dynamic and scalable allocation of bandwidth in a CDMA wireless network.

### BACKGROUND OF THE INVENTION

Wireless communications systems, including cellular phones, paging devices, personal communication services (PCS) systems, and wireless data networks, have become ubiquitous in society. To attract new customers, wireless service providers continually seek to improve wireless services cheaper and better, such as by implementing new technologies that reduce infrastructure costs and operating costs, increase handset battery lifetime, and improve quality of service (e.g., signal reception).

Code division multiple access (CDMA) is a very common and popular platform for providing wireless service. Wireless service providers use CDMA technology to provide both voice and data services to subscribers. The latest versions of CMDA (e.g., IS-2000, 1xEV-DV/DO, and WCDMA) provide a range of improved services to subscribers, including high-speed data connections to support applications such as e-mail, web browsing, and the like.

However, like other wireless technologies, CDMA provides a strict allocation of frequencies and bandwidth to each user mobile station. Wireless network operators seeking additional performance enhancements have requested a more flexible capability that will support CDMA service beyond the existing 1.25 Mhz spectrum allocation.

Therefore, there is a need in the art for improved CDMA wireless network. In particular, there is a need for a CDMA wireless network that is capable of allocating bandwidth in a scalable and dynamic manner to provide better spectral efficiency and improved performance.

### SUMMARY OF THE INVENTION

The present invention provides a mechanism for allocating bandwidth in a dynamic and scalable manner in CDMA wireless networks.

To address the above-discussed deficiencies of the prior art, it is a object of the present invention to provide a CDMA wireless network comprising a plurality of base stations capable of communicating with a plurality of mobile stations in a coverage area of the CDMA wireless network. In some embodiments, at least one of the base stations is capable of allocating a scalable amount of bandwidth to a first mobile station in response to a request received from said first mobile station. In some embodiments, at least some base stations are configured to transmit information indicating the bandwidth and frequencies supported by that base station.

According to some embodiments of the present invention, there is provided a wireless network and base station capable of communicating with a plurality of mobile stations in a coverage area of the wireless network, wherein the base station is configured to transmit information indicating the bandwidth and frequencies supported by that base station.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present invention and its advantages, reference is now made to the following description taken in conjunction with the accompanying drawings, in which like reference numerals represent like parts:

FIG. 1 illustrates an exemplary wireless network in which bandwidth is allocated in a dynamic and scalable manner according to the principles of the present invention;

FIG. 2 illustrates changes made to the MAC layer according to one embodiment of the present invention;

FIG. 3 illustrates a modified RLP BLOB message according to an exemplary embodiment of the present invention; and

FIG. 4 illustrates changes made to the medium access control (MAC) layer according to an exemplary embodiment of the present invention.

### DETAILED DESCRIPTION OF THE INVENTION

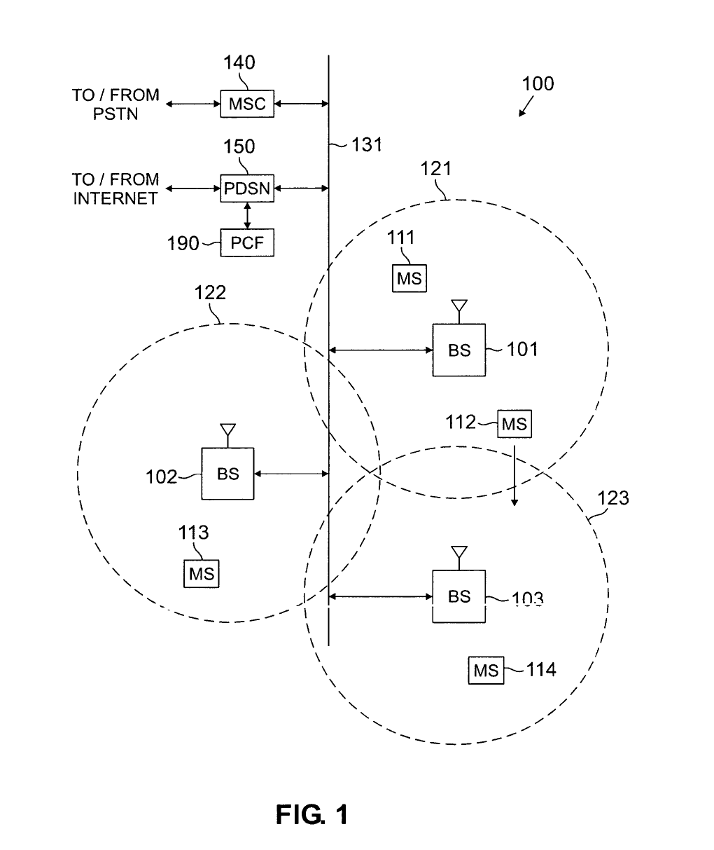

FIGS. 1 through 4, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged CDMA wireless network.

Physical channel names, as used herein, include:

Channel Name Physical Channel

F/R-FCH Forward/Reverse Fundamental Channel

F/R-DCCH Forward/Reverse Dedicated Control Channel

F/R-SCCH Forward/Reverse Supplemental Code Channel

F/R-SCH Forward/Reverse Supplemental Channel

F-PCH Paging Channel

F-QPCH Quick Paging Channel

R-ACH Access Channel

F/R-CCCH Forward/Reverse Common Control Channel

F/R-PICH Forward/Reverse Pilot Channel

F-APICH Dedicated Auxiliary Pilot Channel

F-TDPICH Transmit Diversity Pilot Channel

F-ATDPICH Auxiliary Transmit Diversity Pilot Channel

F-SYNCH Sync Channel

F-CPCCH Common Power Control Channel

F-CACH Common Assignment Channel

R-EACH Enhanced Access Channel

F-BCCH Broadcast Control Channel

F-PDCH Forward Packet Date Channel

F-PDCCH Forward Packet Data Control Channel

R-ACKCH Reverse Acknowledgement Channel

R-CQICH Reverse Channel Quality Indicator Channel

F-ACKCH Forward Acknowledgement Channel

F-GCH Forward Grant Channel

F-RCCH Forward Rate Control Channel

R-PDCH Reverse Packet Data Channel

R-PDCCH Reverse Packet Data Control Channel

R-REQCH Reverse Request Channel

The notations “F/R” and “Forward/Reverse” represent two different physical channels (i.e., one forward channel and one reverse channel). For example, the physical channel name for the Forward Fundamental Channel is F-FCH.

FIG. 1 illustrates exemplary wireless network 100, in which bandwidth is allocated in a dynamic and scalable manner according to the principles of the present invention. Wireless network 100 comprises a plurality of cell sites 121-123, each containing one of the base stations, BS 101, BS 102, or BS 103. Base stations 101-103 communicate with a plurality of mobile stations (MS) 111-114 over code division multiple access (CDMA) channels according to, for example, the IS-2000 standard (i.e., CDMA2000). In an advantageous embodiment of the present invention, mobile stations 111-114 are capable of receiving data traffic and/or voice traffic on two or more CDMA channels simultaneously. Mobile stations 111-114 may be any suitable wireless devices (e.g., conventional cell phones, PCS handsets, personal digital assistant (PDA) handsets, portable computers, telemetry devices) that are capable of communicating with base stations 101-103 via wireless links.

The present invention is not limited to mobile devices. The present invention also encompasses other types of wireless access terminals, including fixed wireless terminals. For the sake of simplicity, only mobile stations are shown and discussed hereafter. However, it should be understood that the use of the term “mobile station” in the claims and in the description below is intended to encompass both truly mobile devices (e.g., cell phones, wireless laptops) and stationary wireless terminals (e.g., a machine monitor with wireless capability).

Dotted lines show the approximate boundaries of cell sites 121-123 in which base stations 101-103 are located. The cell sites are shown approximately circular for the purposes of illustration and explanation only. It should be clearly understood that the cell sites may have other irregular shapes, depending on the cell configuration selected and natural and man-made obstructions.

As is well known in the art, each of cell sites 121-123 is comprised of a plurality of sectors, where a directional antenna coupled to the base station illuminates each sector. The embodiment of FIG. 1 illustrates the base station in the center of the cell. Alternate embodiments may position the directional antennas in corners of the sectors. The system of the present invention is not limited to any particular cell site configuration.

In one embodiment of the present invention, each of BS 101, BS 102 and BS 103 comprises a base station controller (BSC) and one or more base transceiver subsystem(s) (BTS). Base station controllers and base transceiver subsystems are well known to those skilled in the art. A base station controller is a device that manages wireless communications resources, including the base transceiver subsystems, for specified cells within a wireless communications network. A base transceiver subsystem comprises the RF transceivers, antennas, and other electrical equipment located in each cell site. This equipment may include air conditioning units, heating units, electrical supplies, telephone line interfaces and RF transmitters and RF receivers. For the purpose of simplicity and clarity in explaining the operation of the present invention, the base transceiver subsystems in each of cells 121, 122 and 123 and the base station controller associated with each base transceiver subsystem are collectively represented by BS 101, BS 102 and BS 103, respectively.

BS 101, BS 102 and BS 103 transfer voice and data signals between each other and the public switched telephone network (PSTN) (not shown) via communication line 131 and mobile switching center (MSC) 140. BS 101, BS 102 and BS 103 also transfer data signals, such as packet data, with the Internet (not shown) via communication line 131 and packet data server node (PDSN) 150. Packet control function (PCF) unit 190 controls the flow of data packets between base stations 101-103 and PDSN 150. PCF unit 190 may be implemented as part of PDSN 150, as part of MSC 140, or as a stand-alone device that communicates with PDSN 150, as shown in FIG. 1. Line 131 also provides the connection path for control signals transmitted between MSC 140 and BS 101, BS 102 and BS 103 that establish connections for voice and data circuits between MSC 140 and BS 101, BS 102 and BS 103.

Communication line 131 may be any suitable connection means, including a T1 line, a T3 line, a fiber optic link, a network packet data backbone connection, or any other type of data connection. Line 131 links each vocoder in the BSC with switch elements in MSC 140. The connections on line 131 may transmit analog voice signals or digital voice signals in pulse code modulated (PCM) format, Internet Protocol (IP) format, asynchronous transfer mode (ATM) format, or the like.

MSC 140 is a switching device that provides services and coordination between the subscribers in a wireless network and external networks, such as the PSTN or Internet. MSC 140 is well known to those skilled in the art. In some embodiments of the present invention, communications line 131 may be several different data links where each data link couples one of BS 101, BS 102, or BS 103 to MSC 140.

In the exemplary wireless network 100, MS 111 is located in cell site 121 and is in communication with BS 101. MS 113 is located in cell site 122 and is in communication with BS 102. MS 114 is located in cell site 123 and is in communication with BS 103. MS 112 is also located close to the edge of cell site 123 and is moving in the direction of cell site 123, as indicated by the direction arrow proximate MS 112. At some point, as MS 112 moves into cell site 123 and out of cell site 121, a hand-off will occur.

According to the principles of the present invention, in some embodiments, wireless network 100 provides a mechanism for allocating bandwidth in a dynamic and scalable manner between base stations (e.g., BS 101) and mobile stations (i.e., MS 111). Where conventional CDMA systems use 1.25 MHz bandwidth blocks, the disclosed embodiments can take advantage of larger bandwidth blocks, e.g., 2.5 MHz, 5 MHz, 10 MHz, etc. Further, in the preferred embodiment, the bandwidth blocks supported by a given system are not necessarily in contiguous frequency bands.

The disclosed embodiments include a CDMA wireless network comprising a plurality of base stations capable of communicating with a plurality of mobile stations in a coverage area of the CDMA wireless network. The base stations are capable of communicating using bandwidth blocks of various sizes, in various frequency bands. In some embodiments, at least one of the base stations is capable of allocating a scalable amount of bandwidth to a first mobile station in response to a request received from said first mobile station. In some embodiments, at least some base stations are configured to transmit information indicating the bandwidth and frequencies supported by that base station. Preferably, the disclosed embodiments provide the capabilities described herein while retaining the ability to communicate with legacy base stations and mobile stations, as appropriate.

To achieve this, the various embodiments of the present invention modify conventional CDMA technology in the following manner. Signaling messages are modified to include new parameter fields that carry the bandwidth data, the band class number, and the separation between the contiguous bands of frequencies. This information may be transmitted in the base station in the overhead control messages in order to advertise the capability of the BS.

The mobile station should also transmit this information regarding its support functionality for the multi-carrier configuration in the MS Capability Record or in a message (or record) similar to the MS Capability Record. The base station may query the mobile station regarding the same by using the Status Request message. The changes required for supporting flexible and dynamic bandwidth can be made in the following signaling messages: i) Release Order, ii) MS Capabilities, ii) ECAM, iv) Handoff Direction messages, and v) Channel Capability Information, which will include the channel numbers the band class supported and the support of the contiguous bandwidth supported.

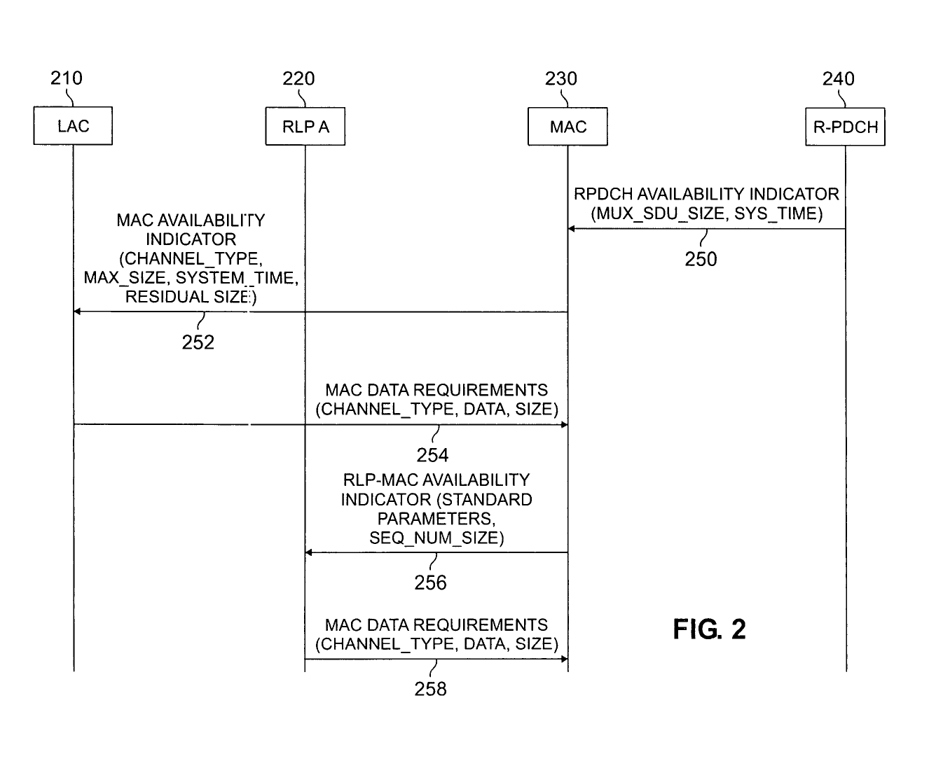

FIG. 2 illustrates changes made to the MAC layer according to one embodiment of the present invention. The present invention makes these changes in the MAC layer to support the multicarrier functionality. According to the physical (PHY) layer changes, the MAC layer changes accordingly. The MAC layer scheduling algorithm takes into consideration the size of the bandwidth available and traffic needed to get disposed. The messages sent or received in the MAC layer, as described herein, should then be supported both by the MAC layer and the other layer, channel, or control.

As illustrated in FIG. 2, the MAC layer receives a RPDCH_Availability_Indicator from the R-PDCH, indicating the available multiplexed system and distribution unit (MUX SDU) size and the system time. The MAC layer also receives a MAX_Data_Requirements message, including channel type, data, and size, from both the LAC layer and the RLP_A layer. The MAC layer sends, to the LAC layer, a MAC_Availability_Indicator message, including channel type, maximum size, system time, and residual size. The MAC layer also sends, to the RLP_A layer, an RLP-MAC_Availability_Indicator message, including standard parameters and a sequence number size. The sequence number size parameter is preferably negotiated as part of the service negotiation.

Other MAC changes needed are as follows: i) MUX PDU sizes remain the same as IS-2000-Rev D; ii) MUX PDU Type 1, 2, 4 and 5 are used for F-PDCH; iii) MUX PDU Type 1, 2, 4 and 7 are used for R-PDCH; and iv) if higher bandwidth PDCH is used, a larger number of MUX PDUs are placed in a single physical PDU.

The changes needed to the radio link protocol (RLP) layer to support dynamic and scalable bandwidth are as follows: i) 12-bit sequence numbers are used, as compared to conventional eight-bit sequence numbers; ii) the MAC layer sends the PDCH Bandwidth information to RLP; iii) if higher bandwidth is used, the RLP may decide to use a larger sequence number; iv) the sequence number size is negotiated with the mobile as part of service negotiation. An additional field is added in RLP “block of bits” (BLOB) to negotiate this parameter. The RLP BLOB is the set of RLP parameters that defines the RLP configuration.

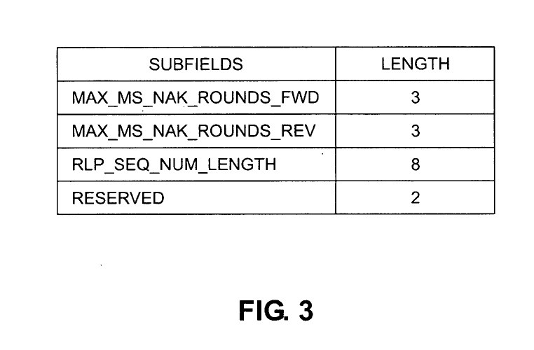

FIG. 3 illustrates a modified RLP BLOB message according to an exemplary embodiment of the present invention. The modified RLP BLOB includes 3 bits each indicating the forward/reverse maximum mobile station non-acknowledgment rounds (MAX_MS_NAK_ROUNDS_FWD/REV), 8 bits indicating the RLP sequence number length (RLP_SEQ_NUM_LENGTH), as described above, and 2 reserved bits.

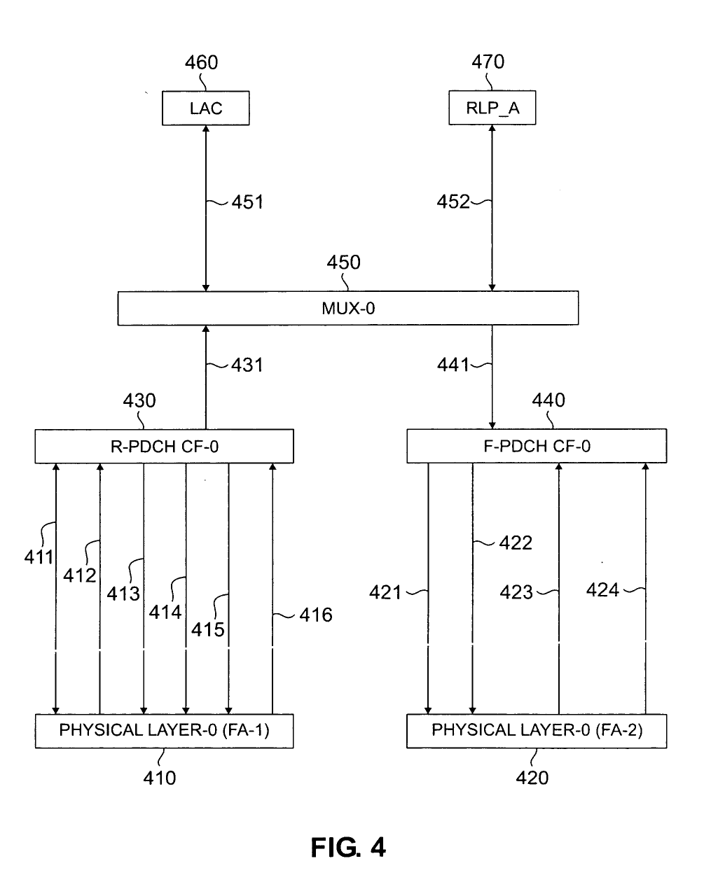

FIG. 4 illustrates changes made to the medium access control (MAC) layer according to an exemplary embodiment of the present invention. As illustrated in this figure, the between the physical layer-0, frequency assignment 1 (FA-1) 410 and the R-PDCH CF-0 430 are F/R-FCH/DCCH/SCH 411, R-PDCH-O/R-PDCCH-0 412, F-ACKCH-0 413, F-RCCH-0 414, F-CCH-0 415, and R-REQCH-0 416. Between physical layer 0 (FA-2) 420 and F-PDCH CF-0 44- are F-PDCH-00/F-PDCCH-00 421, F-PDCH-01/F-PDCCH-01 422, R-ACKCH-0 423, and R-CQICH-0 424. Between R-PDCH CF-0 430 and MUX-0 450 is R-PDCH-0 431, and between FPDCH CF-0 440 and MUX-0 450 is F-PDCH-0 441. Between MUX-0 450 and LAC 460 is F/R-DSCH 451, and between MUX-0 450 and RLP_A 470 is F/R-DTCH_RLPA 551.

Changes are also required in the link access control (LAC) layer. The LAC layer changes needed to support the above mentioned functionality are as follows. When addressing the mobile station, which can have multiple channels on different frequencies, the base station must make sure that the addressing of the information is still being done by a single mobile station address. Thus, the base station should club all the channels information in a single call control instance block.

Although the present invention has been described with an exemplary embodiment, various changes and modifications may be suggested to one skilled in the art. It is intended that the present invention encompass such changes and modifications as fall within the scope of the appended claims.

1. A wireless network comprising a plurality of base stations capable of communicating with a plurality of mobile stations in a coverage area of the wireless network, wherein at least one of the base stations is capable of allocating a scalable amount of bandwidth to a first mobile station in response to a request received from said first mobile station.

2. A wireless network comprising a plurality of base stations capable of communicating with a plurality of mobile stations in a coverage area of the wireless network, wherein at least one of the base stations is configured to transmit information indicating the bandwidth and frequencies supported by that base station.

3. The wireless network of claim 2, wherein the base station supports a MAC layer message that indicates an available multiplexed system and distribution unit (MUX SDU) size.

4. The wireless network of claim 2, wherein the base station supports a MAC layer message that indicates channel type, data, and size.

5. The wireless network of claim 2, wherein the base station supports a MAC layer message that indicates channel type, maximum size, system time, and residual size.

6. The wireless network of claim 2, wherein the base station supports a MAC layer message that indicates standard parameters and a sequence number size.

7. The wireless network of claim 2, wherein the base station supports a radio link protocol layer using 12-bit sequence numbers.

8. The wireless network of claim 2, wherein the base station negotiates a sequence number size with a mobile station as part of service negotiation.

9. The wireless network of claim 2, wherein the base station supports an RLP BLOB message that includes 8 bits indicating the RLP sequence number length.

10. The wireless network of claim 2, wherein the wireless network is a CDMA network.

11. The wireless network of claim 2, wherein the base station supports multiple non-contiguous bandwidth blocks.

12. A base station capable of communicating with a plurality of mobile stations in a coverage area of a wireless network, wherein the base station is configured to transmit information indicating the bandwidth and frequencies supported by the base station.

13. The base station of claim 12, wherein the base station supports a MAC layer message that indicates an available multiplexed system and distribution unit (MUX SDU) size.

14. The base station of claim 12, wherein the base station supports a MAC layer message that indicates channel type, data, and size.

15. The base station of claim 12, wherein the base station supports a MAC layer message that indicates channel type, maximum size, system time, and residual size.

16. The base station of claim 12, wherein the base station supports a MAC layer message that indicates standard parameters and a sequence number size.

17. The base station of claim 12, wherein the base station supports a radio link protocol layer using 12-bit sequence numbers.

18. The base station of claim 12, wherein the base station negotiates a sequence number size with a mobile station as part of service negotiation.

19. The base station of claim 12, wherein the base station supports an RLP BLOB message that includes 8 bits indicating the RLP sequence number length.

20. The base station of claim 12, wherein the base station supports multiple non-contiguous bandwidth blocks.
